(19) United States
(12) Patent Application Publication
(10) Pub. No.: US 2016/0171554 A1
(43) Pub. Date: Jun. 16, 2016

(54) SPONSORED AD-EMBEDDED MESSAGING

(71) Applicant: Michael A. Sharp, Porter, TX (US)

(72) Inventor: Michael A. Sharp, Porter, TX (US)

(21) Appl. No.: 14/966,953

(22) Filed: Dec. 11, 2015

Related U.S. Application Data
(60) Provisional application No. 62/091,280, filed on Dec. 12, 2014.

(51) Int. Cl. G06Q 30/02; H04L 12/58

(52) U.S. Cl. CPC G06Q 30/0269; H04L 51/10; H04L 51/046

(57) ABSTRACT

This disclosure relates to methods and systems for transmitting advertising content to a messaging device and playing and/or viewing the advertisements. In one representative embodiment, a method of transmitting advertising content to a user of a messaging device comprises the user requesting access to a message file on the messaging device. The request can be transmitted over a network to an advertising content server. The method can also comprise transmitting one or more advertisement files to the messaging device from the advertising content server over the network and playing or displaying the one or more advertisements when the message file is accessed on the messaging device.

### CROSS REFERENCE TO RELATED APPLICATION

This application claims the benefit of U.S. Provisional Application Ser. No. 62/091,280, entitled SPONSORED AD-EMBEDDED MESSAGING, filed on Dec. 12, 2014, which is incorporated by reference herein.

### FIELD

This disclosure is related to methods and systems for transmitting sponsored advertisements to a messaging device and methods of playing and/or viewing the advertisements.

### BACKGROUND

Typically, messaging service providers charge a service fee for users to access a messaging service. Upon payment of the service fee, a user can access a messaging inbox and the messages therein. For example, by paying a service fee for cellular telephone, the user can access and listen to their voicemail messages at no additional charge. However, these service fees can be very expensive, which many people do not want to or cannot afford to pay. As a result, many people forgo these services. Furthermore, companies and advertising agencies are constantly searching for new and improved ways to reach consumers. Accordingly, reducing the cost of messaging services as well as providing new advertising methods are always desirable.

### SUMMARY

The methods and systems disclosed herein pertain to transmitting advertising content to a messaging device. In one representative embodiment, a method of transmitting advertising content to a user of a messaging device comprises the user requesting access to a message file on the messaging device. The request can be transmitted over a network to an advertising content server. The method can also comprise transmitting one or more advertisement files to the messaging device from the advertising content server over the network and playing or displaying the one or more advertisements when the message file is accessed on the messaging device. Thus, if a user cannot afford to purchase a messaging service fee, they can elect to receive messages combined with an advertisement paid for by one or more sponsors that plays or displays one or more times.

In another representative embodiment a system for transmitting advertising content to a messaging device comprises a messaging device configured to receive message files, and an advertising content server in communication with the messaging device over a network, the advertising content server having a database containing advertisement files. The advertising content server can be configured to receive a request from the messaging device that the users is accessing a message file and transmit one or more advertisement files to the messaging device when such a request is received. The advertisements files can be configured to play or display when the message file is accessed on the messaging.

In another representative embodiment, the messaging device can be a mobile phone.

In another representative embodiment, the message file can be a voicemail message.

In another representative embodiment the message file can be a multimedia message file comprising text, audio, or video data.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic representation of a computing environment in which certain embodiments of the systems and methods disclosed herein can be implemented.

FIG. 2 is a schematic representation of a computer network.

FIG. 3 is a schematic representation of a system for identifying and retrieving advertising content on demand.

FIG. 4 is a block diagram illustrating how a computer network can be used to retrieve and transmit advertising content on demand.

### DETAILED DESCRIPTION

### General Considerations

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “provide” to describe the disclosed methods. These terms are high-level abstractions of the actual operations that are performed. The actual operations that correspond to these terms may vary depending on the particular implementation and are readily discernible by one of ordinary skill in the art.

As used herein, the terms “a”, “an” and “at least one” encompass one or more of the specified element. That is, if two of a particular element are present, one of these elements is also present and thus “an” element is present. The terms “a plurality of” and “plural” mean two or more of the specified element. As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.”

### Illustrative Operating Environment

Various systems for providing supplemental data to users during message transfer actions are described below. In some embodiments, these systems—including the transfer of messages and the associated supplemental data—may be implemented or performed, at least in part, by software stored on one or more tangible computer-readable media (e.g., one or more optical media discs, volatile memory or storage components (such as DRAM or SRAM), or nonvolatile memory or storage components (such as hard drives)) and executed on one or more computing systems. Some basic background information relating to computing systems capable of transferring messages as discussed above are provided.

The computing systems can include one or more central processing units (CPUs) and a memory, such as random access memory (RAM) for temporary storage of information and/or a read only memory (ROM) for permanent storage of information, and a mass storage device, such as a hard drive, diskette, or optical media storage device. Typically, the modules of the computing system are connected to the computer using a standards-based bus system, such as, for example, Peripheral Component Interconnect (PCI), Microchannel, SCSI, Industrial Standard Architecture (ISA) and Extended ISA (EISA) architectures. The computing system may also include one or more commonly available input/output (I/O) devices and interfaces, such as a keyboard, a mouse, and/or a touchpad. In one embodiment, the I/O devices and interfaces include one or more display devices, such as a monitor, that allows the visual presentation of data to a user. More particularly, a display device provides for the presentation of Graphical User Interfaces (GUIs), application software data, and multimedia presentations, for example. The computing system may also provide a communications interface to various external devices.

Such software can be executed on a single computer or on a networked computer (e.g., via the Internet, a wide-area network, a local-area network, a client-server network, or other such network). The systems and methods disclosed herein can also be performed using cloud computing, a form of Internet-based computing, whereby shared resources, software and information are provided to computers and other devices on-demand. The software embodiments disclosed herein can be described in the general context of computer-executable instructions, such as those included in program modules, which can be executed in a computing environment on a target real or virtual processor. The computing system may run on a variety of computing devices, such as, for example, a server, a Windows server, a Structure Query Language server, a Unix server, a personal computer, a mainframe computer, a laptop computer, a cell phone, a personal digital assistant, a kiosk, a multimedia player, and so forth. The computing system is generally controlled and coordinated by operating system software. Conventional operating systems control and schedule computer processes for execution, perform memory management, provide file system, networking, and I/O services, and provide a user interface, such as a graphical user interface, among other things.

Furthermore, any of the software embodiments (comprising, for example, computer-executable instructions for causing a computer to perform any of the disclosed methods) can be transmitted, received, or accessed through a suitable communication means. Similarly, any data structure, data file, intermediate result, or final result created or modified using any of the disclosed methods can be transmitted, received, or accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means now known or unknown. Moreover, any data structure, data file, intermediate result, or final result produced by any of the disclosed methods can be displayed to a user using a suitable display device (e.g., a computer monitor or display). Such displaying can be performed as part of a computer-implemented method of performing any of the disclosed methods. As the techniques of the disclosed technology may be implemented using a programmable computer system executing software instructions, the components and operation of a computer system on which various implementations of the disclosed technology may be employed is described.

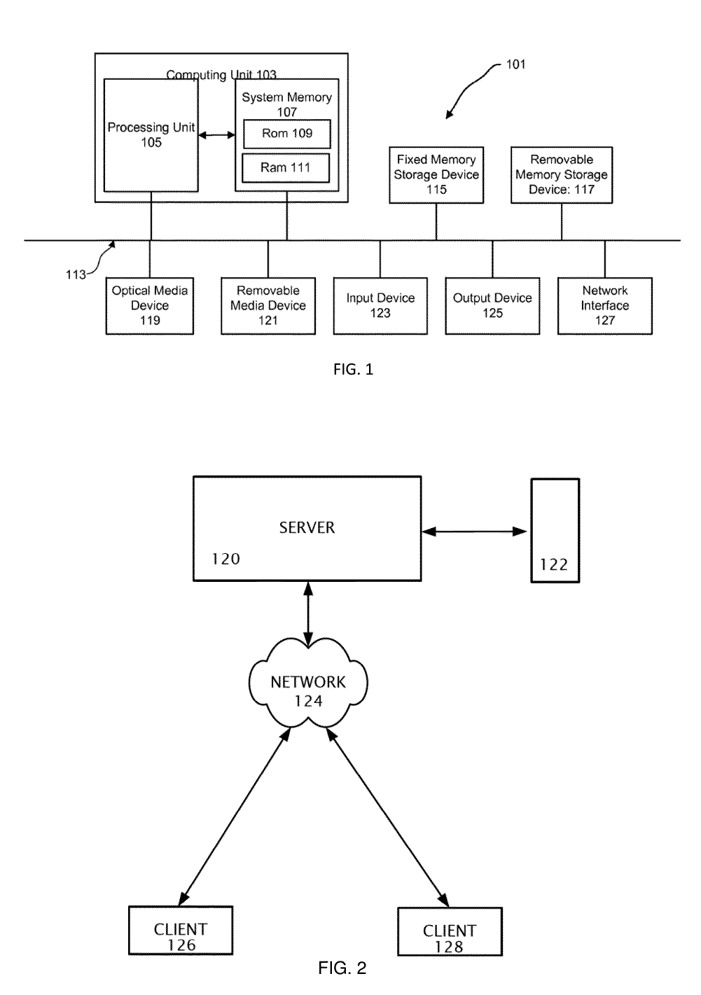

Accordingly, FIG. 1 shows an illustrative computing device 101. As shown, the computing device 101 includes a computing unit 103 having a processing unit 105 and a system memory 107. The processing unit 105 may be any type of programmable electronic device for executing software instructions, but will conventionally be a microprocessor. The system memory 107 may include a read-only memory (“ROM”) 109 and/or a random access memory (“RAM”) 111. As will be appreciated by those of ordinary skill in the art, either or both of the ROM 109 or the RAM 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional devices, such as: a fixed memory storage device 115, for example, a magnetic disk drive; a removable memory storage device 117, for example, a removable solid state disk drive; an optical media device 119, for example, a digital video disk drive; or a removable media device 121, for example, a removable drive. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computing device 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (“USB”) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (“TCP”) and the Internet protocol (“IP”). Also, the interface 127 may employ any suitable connection agent (or combination of agents) for connecting to a network, including, for example, a wireless transceiver, a modem, or an Ethernet connection.

It should be appreciated that the computing device 101 is shown here for illustrative purposes only, and it is not intended to be limiting. Various embodiments of the invention may be implemented using one or more computers that include the components of the computing device 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, a mobile computing device such as a smartphone, tablet, or portable multimedia player, or any combination thereof.

As stated above, various embodiments of the invention may be implemented using a programmable computer system executing software instructions, a computer readable medium having computer-executable software instructions stored thereon, or some combination thereof. Particularly, these software instructions may be stored on one or more computer readable media or devices, such as, for example, the system memory 107, or an optical disk for use in the optical media device 119. As those of ordinary skill in the art will appreciate, software instructions stored in the manner described herein are inherently non-transitory in nature. More specifically, the software instructions are available for execution by the computer system 101, as opposed to being transmitted to the computer system via a carrier wave or some other transitory signal.

FIG. 2 shows a simplified embodiment of an exemplary network that can achieve message transfers as described herein. A server computer 120 can have an associated storage device 122 (internal or external to the server computer). The server computer 120 can be coupled to a network, shown generally at 124, which can comprise, for example, a wide-area network, a local-area network, a client-server network, the Internet, or other such network. One or more client computer (e.g., a user's computing device), such as that shown at 126 can be coupled to the network 124 using a network protocol. When downloading or streaming a message from network 124, supplemental data can be delivered prior to or at the same time as the message being transferred from network 124 to user computer 126.

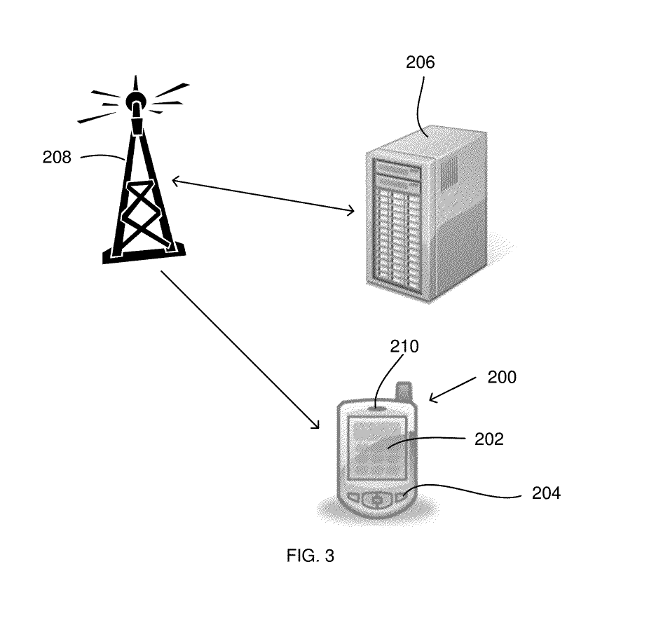

FIG. 3 shows one embodiment of a messaging device 200 configured, for example, as a smartphone. The messaging device 200 can be configured to send and receive a variety of message types (e.g., voicemail, email, text, picture, video, etc.) In some embodiments, the messaging device 200 can comprise a screen 202, a messaging button 204, and a speaker 210, in addition to the functionality found on conventional smartphones (e.g., call, web browser, media player, etc.). FIG. 3 also shows that the messaging device 200 can be in communication with a messaging provider service, including at least one server, represented generally at 206. When a user receives a notification or alert that the user has a new message (e.g., text, video, voice, etc.), the user can press the messaging button 204 request access to and/or view the message. The messaging device 200 can send a request to access to the messaging provider service 206. When the messaging provider service receives the request, the messaging provider service can transmit (e.g., stream) an advertising content to the messaging device 200, as shown in FIG. 3. In some embodiments, as shown, the message can be transmitted over a wireless network 218, such as a cellphone network or a wireless local area network (LAN).

In some embodiments, an advertisement can be transmitted to the user at the same time as the message file. In some embodiments, an advertisement can be transmitted to the user prior to allowing the user to access the message. In this manner, the advertisement can be played before or after playback or viewing of the message by the user.

Each message, or each delivery of a message, can have one or more sponsors. The one or more sponsors can provide the advertisements that are combined with the message file before the message file is delivered to the user. Each time an advertisement is played or viewed in connection with a message, the originating sponsor of the advertisement can be charged a fee. In this manner, the fees charged to sponsors can provide messaging provider services with an additional revenue stream. With increased revenue, the messaging provider services can lower service charges paid by a user and/or improve profits.

In some embodiments, the advertisements transmitted to the user can comprise audio advertisements and can be from about five seconds to about sixty seconds long. The advertisements can be configured to play the first time the message file is played and/or viewed by the user, every time the message is played and/or viewed by the user, or any other suitable number of times. In some embodiments, the length of the advertisement, number of advertisements associated with the message, and the number of times the advertisement plays after receipt of the message by the user can depend upon, for example, the type of message (e.g., email, voicemail, voice note, text message, video message, picture message, etc.), or the fee paid by the sponsor, etc. For example, in some embodiments, an advertisement associated with a message can play or display the first time that the user listens to and/or views the message and then never play again. In other embodiments, the advertisement can play or display a specified number of times (e.g., three times, five times, ten times, etc.) or every time the user listens to and/or views the message.

In some embodiments, the messaging provider services can specify the fee to be paid by a sponsor for playback or viewing of an advertisement with a particular message. In alternative embodiments, the sponsors can bid for the privilege of having their advertisement transmitted with a message in real time as requests for messages are received from users. In other embodiments, sponsors can specify an amount that they will pay for their advertisement to be transmitted with a message, and messaging provider services can specify the amount that they wish to charge, and the messaging provider services can match advertisements and message files for transmission in accordance with the price parameters established by the sponsors and providers.

In some embodiments, the speaker 210 of the messaging device 200 can play an audible advertisement. For example, the user can hear “This voicemail message is brought to you by PEPSI®” through the speaker 210 of the messaging device 200. In some embodiments, the screen 202 of the messaging device 200 can also display textual advertising content while the message file is being played and/or viewed. For example, the textual advertising content can read “Brought to you by PEPSI®.” In some embodiments, the textual advertising content and the audio advertisement embedded or streamed with the message file can originate with the same sponsor, or from different sponsors. In some embodiments, the advertisement can include audio, text, video, and/or pictures. In some embodiments, the advertisement can include any combination of audio, text, video, and/or pictures.

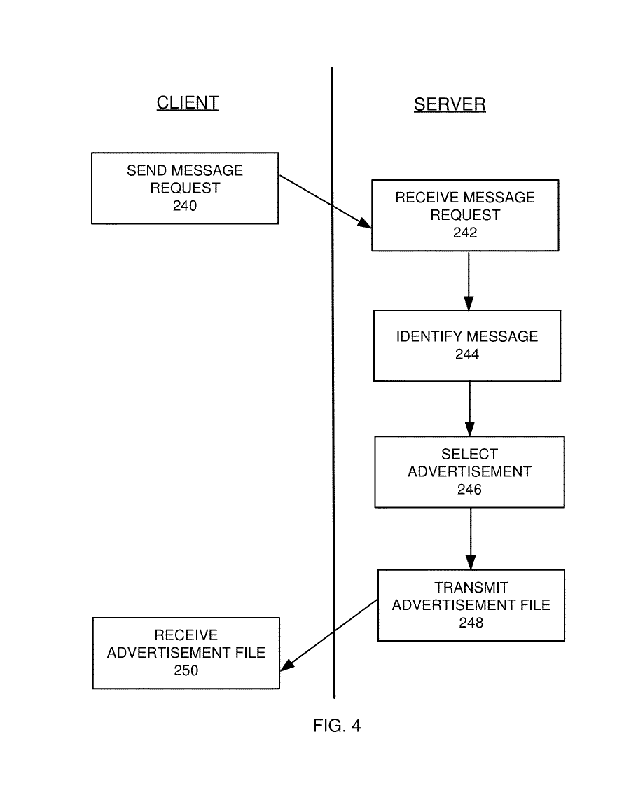

FIG. 4 shows an exemplary manner in which computer-executable instructions for performing any of the disclosed embodiments can be transmitted, accessed, or received using a remote server computer or a remote computing environment, such as the computing device 101. At process block 240, for example, the client messaging device sends a request to access a message, such as a voicemail message on a mobile phone or smartphone. The request can contain a data file comprising data, such as type of message requested (e.g., voicemail, text, email, etc.).

In process block 242, the request is received by the remote server or by respective components of the remote computing environment. In process block 244, the remote server or computing environment uses the data contained in the request to identify the message requested by the user. In process block 246, the remote server or remote computing environment selects one or more advertisements, and transmits the advertisement file to the user in block 248. The advertisement file is received (e.g., buffered, and/or executed) by the client messaging device at block 250. In this manner, the user can receive an advertisement prior to accessing the requested message.

In some embodiments, a user of a messaging service can receive advertisement transmissions to reduce the fee charged to the user by the messaging service provider. For example, in exchange for receiving messages with advertising, the user's month service fee can be reduced by a flat rate. In some embodiments, a user's service charge can be reduced proportionately to the number of advertisements the user views or plays. For example, the more messages and thus advertisements the user views or plays, the less the user pays for the message service.

In some embodiments, an advertisement file can be transmitted to a messaging device in a separate transmission from the message file transmission. For example, the advertisement file can be transmitted prior to the message file. In some embodiments, the message file and the advertisement file can, for example, be transmitted simultaneously.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. One or more computer-readable media storing computer-executable instructions for causing a computer to perform a method of transmitting advertising content to a user of a messaging device, the method comprising:
the user requesting access to a message file on the messaging device, the request being transmitted over a network to an advertising content server;
transmitting one or more advertisement files to the messaging device from the advertising content server over the network; and
playing or displaying the one or more advertisements when the message file is accessed on the messaging device.

2. The method of claim 1, wherein the messaging device is a mobile phone.

3. The method of claim 1, wherein the message file is a voicemail message.

4. The method of claim 1, wherein the message file is a multimedia message file comprising text, audio, or video data.

5. The method of claim 1, wherein the messaging device is configured to track the number of times that the one or more advertisements have been played.

6. The method of claim 5, wherein:
the user pays a service fee for accessing messages; and
the user receives a discount on the service fee corresponding to the number of times that the one or more advertisements were played on the messaging device.

7. A system for transmitting advertising content to a user of a messaging device, comprising:
a messaging device configured to receive message files; and
an advertising content server in communication with the messaging device over a network, the advertising content server having a database containing advertisement files;
wherein the advertising content server is configured to receive a request from the messaging device that the users is accessing a message file and transmit one or more advertisement files to the messaging device when such a request is received; and
wherein the one or more advertisements files are configured to play or display when the message file is accessed on the messaging.

8. The system of claim 7, wherein the messaging device is a mobile phone.

9. The system of claim 7, wherein the message file is a voicemail message.

10. The system of claim 7, wherein the message file is a multimedia message file comprising text, audio, or video data.

11. The system of claim 7, wherein the messaging device is configured to track the number of times that the one or more advertisements have been played.

12. The method of claim 11, wherein:
the user pays a service fee for accessing messages; and
the user receives a discount on the service fee corresponding to the number of times that the one or more advertisements were played on the messaging device.
